(19) United States
(12) Patent Application Publication
(10) Pub. No.: US 2012/0229727 A1
(43) Pub. Date: Sep. 13, 2012

(54) ILLUMINATION DEVICE AND IMAGE DISPLAY DEVICE EMPLOYING THE SAME

(76) Inventors: Seiji MURATA, Fujisawa (JP); Satoshi OUCHI, Kamakura (JP)

(21) Appl. No.: 13/325,919

(22) Filed: Dec. 14, 2011

(30) Foreign Application Priority Data
Mar. 7, 2011 (JP) 2011-048838

(51) Int. Cl. G02F 1/1335; F21V 7/04; F21V 7/00

(52) U.S. Cl. 349/61; 362/217.05; 362/217.07

(57) ABSTRACT

The object of the present invention is to achieve weight reduction of an illumination device and uniformization of luminance distribution. The illumination device (backlight unit) comprises a linear light source, a reflecting layer and an outlet layer. The reflecting layer and the outlet layer face each other via space. The linear light source is arranged at an end of the space. The outlet layer is formed as a semi-transmissive layer which transmits part of incident light while reflecting part of the incident light. The cross-sectional shape of the reflecting layer has an apex, which is concave in an illuminating direction, in a section from a position close to the linear light source to a central position of the reflecting layer and an inflection point in a section from the apex to a distal end of the reflecting layer.

### CLAIM OF PRIORITY

The present application claims priority from Japanese patent application serial No. JP 2011-048838, filed on Mar. 7, 2011, the content of which is hereby incorporated by reference into this application.

### BACKGROUND OF THE INVENTION

(1) Field of the Invention

The present invention relates to an illumination device suitable for low-profiling and an image display device employing such an illumination device as its backlight.

(2) Description of the Related Art

In recent years, low-profiling and higher efficiency are being required of illumination devices and backlight units installed in liquid crystal displays. For the low-profiling of illumination devices used as backlight units, methods employing a light guide plate are generally used. JP-A-2005-17355 has disclosed a liquid crystal display in which a cold cathode fluorescent lamp (CCFL) is arranged at one end (edge) of an edge light-type backlight employing the light guide plate. Under the light guide plate, a reflecting plate for upwardly guiding the light emitted by the backlight is placed. Two polarization plates are arranged over and under a liquid crystal panel.

### SUMMARY OF THE INVENTION

The light guide plate is effective for the low-profiling of illumination devices. However, in illumination devices whose illuminating surface is illuminated by use of one light guide plate, the upsizing of the illuminating surface leads to a considerably heavy weight of the light guide plate and that impedes the weight reduction of the illumination device. Further, when a large-sized light guide plate is used, the illuminating light at each part of the illuminating surface tends to become darker with the increase in the distance from the light source, which makes it difficult to uniformize the luminance. The JP-A-2005-17355 has not considered any method to achieve both of the weight reduction of the illumination device and the uniformization of the luminance distribution.

The object of the present invention, which has been made in consideration of the above problem, is to provide an illumination device and an image display device capable of achieving the weight reduction and the uniformization of the luminance distribution.

An illumination device in accordance with the present invention comprises a linear light source; a reflecting layer which reflects light emitted by the linear light source; and an outlet layer which faces the reflecting layer and outputs illuminating light; wherein the reflecting layer and the outlet layer face each other via space, and the linear light source is arranged at an end of the space, and the outlet layer is a semi-transmissive layer which transmits part of incident light while reflecting part of the incident light.

Preferably, a cross-sectional shape of the reflecting layer is set as a curved line extending along a direction orthogonal to the lengthwise direction of the linear light source. The curved-line shape has an apex, which is concave in an illuminating direction, in a section from a position close to the linear light source to a central position of the reflecting layer and an inflection point, where the rate of change of the gradient of the curved line equals zero, in a section from the apex to a distal end of the reflecting layer.

According to the present invention, the weight reduction of the illumination device and the uniformization of the luminance distribution can be achieved by implementing the illumination device in a configuration leaving out the light guide plate.

### BRIEF DESCRIPTION OF THE DRAWINGS

These and other features, objects and advantages of the present invention will become more apparent from the following description when taken in conjunction with the accompanying drawings wherein:

FIG. 1 is a schematic diagram showing the configuration of an illumination device (backlight unit) in accordance with a first embodiment of the present invention;

FIG. 2 is an exploded view of the illumination device of FIG. 1;

FIG. 3 is a ray diagram showing a semi-transmissive function of a polarization-selective reflecting sheet;

FIG. 4 is a ray diagram showing the semi-transmissive function of a prism sheet;

FIG. 5 is a schematic diagram showing the shape of a reflecting layer of an illumination device in accordance with a second embodiment of the present invention;

FIG. 6 is a ray diagram showing reflection of rays of light by the reflecting layer formed in the shape shown in FIG. 5;

FIG. 7 is a ray diagram showing a case where the reflecting layer is formed in a planar shape for comparison;

FIG. 8 is a schematic diagram showing the configuration of an illumination device in accordance with a third embodiment of the present invention;

FIG. 9 is a front view showing an image display device (liquid crystal display) in accordance with a fourth embodiment of the present invention; and

FIG. 10 is a schematic diagram showing the internal configuration of the image display device of FIG. 9.

### DETAILED DESCRIPTION OF THE EMBODIMENTS

Referring now to the drawings, a description will be given in detail of preferred embodiments in accordance with the present invention.

### First Embodiment

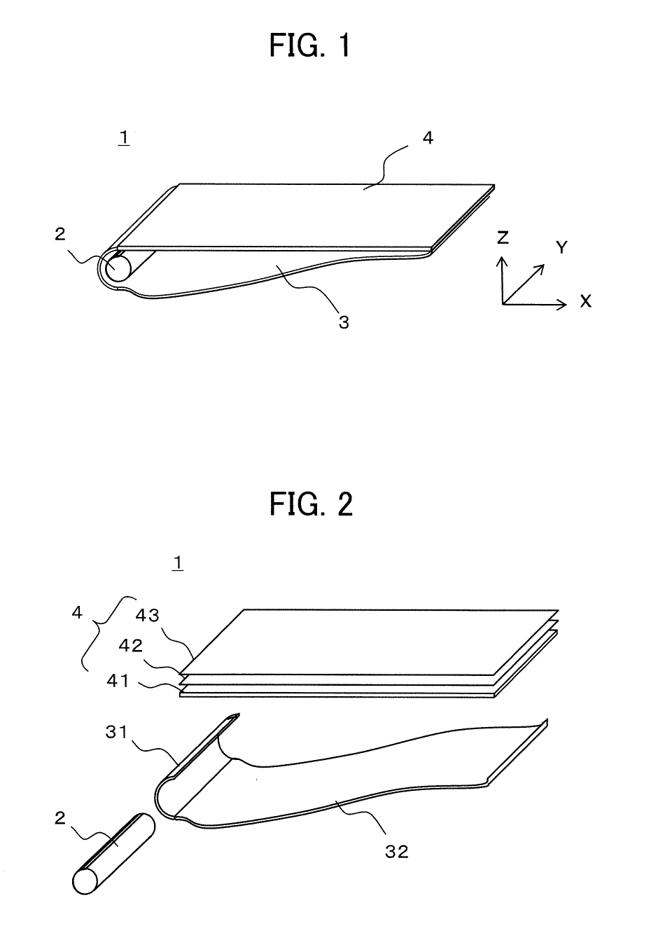

FIGS. 1 and 2 are schematic diagrams showing the configuration of an illumination device in accordance with a first embodiment of the present invention. In this embodiment, a backlight unit used for a liquid crystal display is illustrated as an example of the illumination device. FIG. 1 shows the backlight unit in the assembled state, while FIG. 2 shows the backlight unit in the disassembled state. The following explanation will be given by use of the X, Y and Z directions shown in FIG. 1.

The backlight unit 1 includes at least one linear light source 2, a reflecting layer 3 and an outlet layer 4. The linear light source 2 has its major axis in the Y direction. The reflecting layer 3 and the outlet layer 4 are substantially in parallel with the X-Y plane. The reflecting layer 3 and the outlet layer 4 oriented in the Z direction face each other via space. Thus, the conventional light guide plate employed in the JP-A-2005-17355, etc. is left out. The outlet layer 4 is formed as a semi-transmissive layer which transmits (lets through) part of the incident light while reflecting part of the incident light. Rays of light emitted by the linear light source 2 are output in the Z direction (upward in FIGS. 1 and 2) through the outlet layer 4 while they are reflected between the reflecting layer 3 and the outlet layer 4.

The composition of each component of the backlight unit 1 will be explained in detail below. The linear light source 2 is implemented by a fluorescent lamp such as a cold cathode fluorescent lamp (CCFL), a hot cathode fluorescent lamp (HCFL) or an external electrode fluorescent lamp (EEFL). A fluorescent lamp is generally formed by coating the inner surface of a glass tube with fluorescent material and filling the glass tube with a gas which is used for causing electric discharge for generating light for the excitation of the fluorescent material. The fluorescent material may be blended corresponding to emission colors required of the backlight unit 1. An example of a composition effective for a liquid crystal panel used for displaying color images will be described here. Each color filter of a liquid crystal panel used for a liquid crystal display has the function of transmitting (letting through) light in a particular wavelength range only. Thus, in order to make the liquid crystal panel transmit (let through) light with high efficiency, multiple fluorescent materials may be employed for the linear light source 2 so that the peaks of the light emitted by the fluorescent materials correspond to the transmitting (transparent) wavelength ranges of the color filters, respectively. While three wavelengths of red, green and blue (RGB) are generally used, it is also possible, as needed, to use a light source employing fluorescent materials having an emission spectrum with more peaks.

The linear light source 2 does not necessarily have to be one light source; the linear light source 2 may also be formed by arranging a plurality of LED light sources. While an LED light source emits light having a spectrum corresponding to the fluorescent material used for the LED light source, the emission spectrums of the plurality of LED light sources are desired to correspond to the emission colors required of the backlight unit 1. Such a composition may be implemented either by combining a plurality of LED light sources having substantially identical emission spectrums or by combining multiple types of LED light sources having different emission spectrums. The linear light source 2 may also be formed by use of laser light sources, organic EL light sources, etc.

The linear light source 2 may be equipped, as needed, with an optical component having a color mixing function or means for uniformizing the luminance or adjusting the light distribution. A lens, a flat plate having the diffusing function, or a prism sheet can be used, for example. However, these examples do not restrict the composition of the linear light source 2.

The reflecting layer 3 is made up of a light source backing part 31 which is placed at the back (in the −X direction) of the linear light source 2 and a base part 32 which serves as the base of the backlight unit 1. The light source backing part 31 and the base part 32 may either be formed separately or integrally. The light source backing part 31 reflects the light emitted in the −X direction by the linear light source 2 in the +X direction. The base part 32 reflects incident light (from the linear light source 2 or the outlet layer 4) toward the outlet layer 4. It is desirable that the reflecting layer 3 be made of material that is easy to process. The reflecting layer 3 can be formed by executing the sheet metal processing to a metal plate (aluminum, silver, steel, titanium, alloy, etc.) that has already been mirror finished, or by executing a reflection process to the surface of a base material that has been formed in the shape of the reflecting layer 3 by injection molding or extrusion. The base material may be made of resin (PMMA, polycarbonate, etc.), metal (e.g. aluminum), etc. The reflection process can be implemented by metal vapor deposition, metal plating, bonding of a dielectric multilayer film, etc.

In the cases where the reflecting layer 3 is made of metal, the reflectance is high. However, the color of the reflected light can differ from that of the incident light since each metal has its own particular spectral properties. In contrast, when a dielectric multilayer film is used, a substantially constant and high reflectance in the visible wavelength range can be achieved by properly selecting the materials.

Incidentally, the reflectance (or the transmittance) of the reflecting layer 3 may be changed partially. For realizing such optical properties, it is possible to partially form (or remove) reflecting films or print a pattern (pattern printing) using light-reflecting ink, light-absorbing ink, etc. In order to give a light-diffusing property to part or all of the reflecting layer 3, it is possible to provide the reflecting layer 3 with a sheet-like optical component or execute printing on the reflecting layer 3. The diffusing function may also be implemented by surface roughness.

The outlet layer 4 is a semi-transmissive layer having the function of reflecting part of the incident light to the incident side (i.e., to the inside of the backlight unit 1) while transmitting (letting through) part of the incident light to the outside of the backlight unit 1. For realizing the function of the semi-transmissive layer, a polarization-selective reflecting sheet 41 and a prism sheet 43 are overlaid. Between the polarization-selective reflecting sheet 41 and the prism sheet 43, a diffusive sheet 42 is inserted. With this composition, unevenness of the brightness of the light emerging from the polarization-selective reflecting sheet 41 is smoothed and reduced by the diffusive sheet 42. The light condensing function of the prism sheet 43 has the effect of increasing the gain and increasing the front brightness. Incidentally, the composition and the stacking order (in the Z direction) of the outlet layer 4 are not restricted to this particular example. It is possible to leave out the diffusive sheet 42, or leave out either the polarization-selective reflecting sheet 41 or the prism sheet 43. The number of the optical sheets used for the outlet layer 4 may be increased as needed.

While the outlet layer 4 is in a shape like a rectangular plane in FIGS. 1 and 2, the shape of the outlet layer 4 is not restricted to this example. The outlet layer 4 may also be formed in a shape defined by a closed curve (circle, ellipse, etc.) or in a shape of a three-dimensional curved surface (part of a spherical surface, a cylindrical shape, etc.), for example.

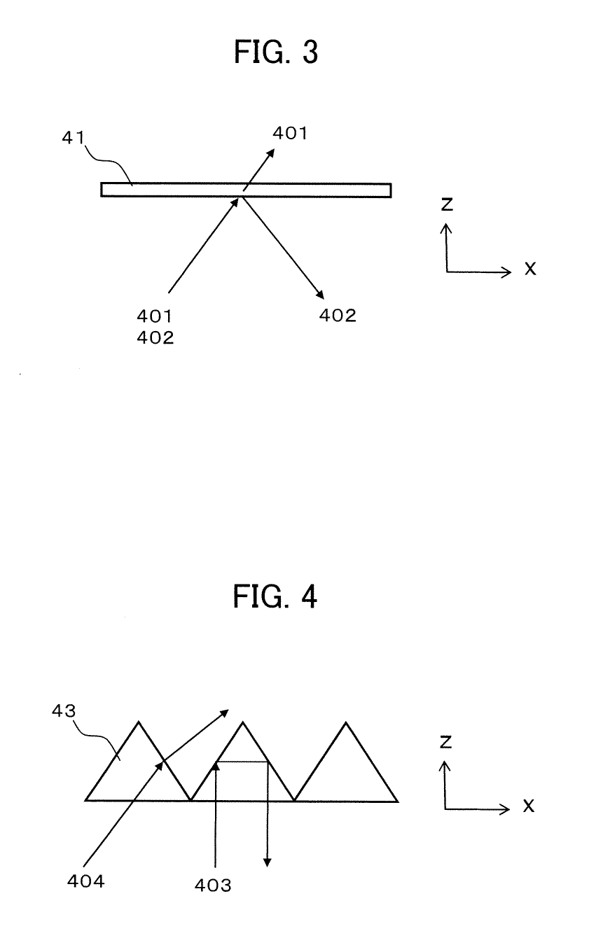

Next, the function of the outlet layer 4 as the semi-transmissive layer will be explained below. FIG. 3 is a ray diagram showing the semi-transmissive function of the polarization-selective reflecting sheet 41 of the outlet layer 4. The polarization-selective reflecting sheet 41 functions as a semi-transmissive layer by transmitting light 401 in a particular polarization direction while reflecting light 402 in the other polarization directions. Depending on the situation, a sheet designed to reflect part of the polarized light transmitted (let through) by the sheet may be used. It is also possible to implement the semi-transmissive layer by a half mirror which reflects/transmits the incident light independently of its polarization direction.

FIG. 4 is a ray diagram showing the semi-transmissive function of the prism sheet 43 of the outlet layer 4. Light 403 substantially vertically incident upon the prism sheet 43 is reflected to the incident side due to the total reflection function of the prisms. Meanwhile, light 404 obliquely incident upon the prism sheet 43 is refracted by the prisms and thereby separated into light reflected toward the light source (total reflection) and light passing through the prism sheet 43 to the side opposite to the light source. Thus, the prism sheet 43 functions as a semi-transmissive layer.

As above, part of the light incident upon the outlet layer 4 (semi-transmissive layer) passes through the outlet layer 4 and is output upward in the Z direction. The remaining part of the light is reflected by the outlet layer 4, propagates toward the reflecting layer 3, reflected by the reflecting layer 3, and propagates toward the outlet layer 4 again. At the outlet layer 4, part of the light is transmitted and the remaining part is reflected. By the repetition of this process, the structure inside the backlight unit 1 propagates the light in the X direction opposite to the linear light source 2 while outputting the light in the Z direction from the outlet layer 4.

Incidentally, the reflectance (or the transmittance) of the semi-transmissive layer may be changed partially. For realizing such optical properties, it is possible to partially form (or remove) reflecting films or print a pattern (pattern printing) using light-reflecting ink, light-absorbing ink, etc. In order to give a light-diffusing property to part or all of the outlet layer 4, it is possible to provide the outlet layer 4 with a sheet-like optical component or execute printing on the outlet layer 4. The diffusing function may also be implemented by surface roughness.

As described above, according to this embodiment, the backlight unit 1 (illumination device) has the function of propagating the light from the linear light source 2 to the distal end of the outlet layer 4 in the X direction similarly to the conventional light guide plate even though the light guide plate is left out. Since the light guide plate is left out and the region occupied by the light guide plate is released as free space in this embodiment, weight reduction of the backlight unit 1 can be achieved. Further, since the propagation of light is implemented without the light guide plate, attenuation during the propagation can be eliminated and the illumination efficiency can be increased.

The configuration of the backlight unit 1 has been illustrated in FIGS. 1 and 2. By combining the backlight unit 1 with a housing, power supply, controller, etc., the backlight unit 1 can be used as an illumination device for any purpose.

### Second Embodiment

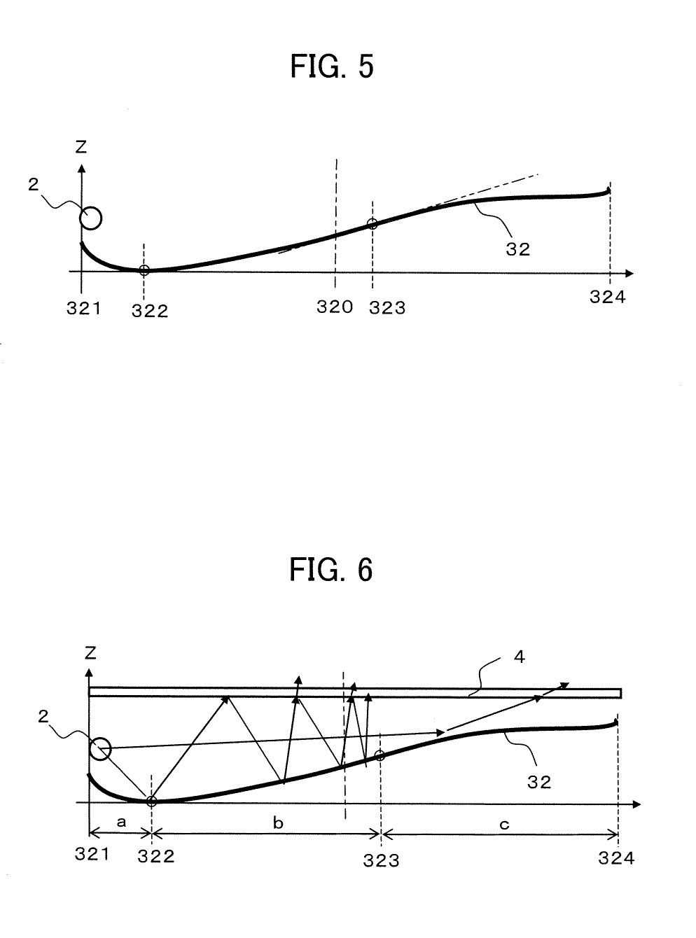

A second embodiment of the present invention will be described below with reference to FIGS. 5-7. The second embodiment is characterized in that the cross-sectional shape of the reflecting layer 3 in the first embodiment is set as a curved line.

FIG. 5 is a schematic diagram showing a cross-sectional shape of the base part 32 (component of the reflecting layer 3 facing the outlet layer 4 in the backlight unit 1 shown in FIG. 2) extending in the X direction. The cross-sectional shape of the base part 32 is set not as a straight line but as a curved line extending along the X direction which is orthogonal to the lengthwise direction of the linear light source 2 (Y direction). The curved-line shape has an apex 322 (concave in the illuminating direction (Z direction)) in a section from a proximal end (starting point) 321 close to the linear light source 2 to a central position 320 in the X direction, and an inflection point 323 in a section from the apex 322 to a distal end 324 in the X direction. At the inflection point 323, the rate of change of the gradient of the curved line equals zero (d²Z/dX²=0). Such a curved-line shape can be approximated by a combination of a cubic curve and an arc, for example. The curved-line shape may have more than one apex 322 and/or more than one inflection point 323. In such cases, the curved-line shape can be approximated by connecting cubic curves and arcs, for example. The cross-sectional shape of the reflecting layer 3 shown in FIG. 5 is just an example. The cross-sectional shape is appropriately determined according to the structure of the backlight unit 1, the number and arrangement of the linear light sources 2, etc. For example, when two linear light sources 2 are arranged at both ends of the reflecting layer 3 (one at each end), the reflecting layer 3 may be formed in a shape symmetrical with respect to a central position 320 in the X direction by connecting two identical cross-sectional shapes of the reflecting layer 3 (like the one shown in FIG. 5) together symmetrically.

FIG. 6 is a ray diagram showing reflection of rays of light by the reflecting layer 3 formed in the shape shown in FIG. 5. Among the rays of light emitted by the linear light source 2, rays of light incident upon an area “a” between the proximal end 321 and the apex 322 of the reflecting layer 3 are reflected so that their density becomes higher in a region farther than the apex 322 in the X direction. Thus, the luminance in the vicinity of the proximal end 321 is suppressed and the luminance in the region farther than the apex 322 is increased. Rays of light incident upon an area “b” between the apex 322 and the inflection point 323 are reflected directly toward the outlet layer 4 facing the area b, by which the luminance in the central part in the X direction is maintained. Meanwhile, rays of light reflected by an area “c” between the inflection point 323 and the distal end 324 diverge toward the distal end of the outlet layer 4 in the X direction and increases the luminance around the distal end. Consequently, the rays of light reflected by the areas a, b and c overlap one another and the luminance distribution on the outlet layer 4 can be more uniformized throughout the area from the vicinity of the linear light source 2 to the distal end in the X direction.

In the cases where an illumination device is used as a backlight unit of a liquid crystal display, etc., luminance distribution enhancing the luminance in the central part of the screen compared to the peripheral part of the screen is desirable since the image quality in the central part is more important. For such a purpose, it is desirable to correct the shape of the reflecting layer to a shape that reduces the ray density at both ends of the outlet layer and correspondingly increases the ray density in the central part of the outlet layer. With such a configuration, a backlight unit having the luminance peak in the central part of the screen and excelling in the power efficiency can be realized.

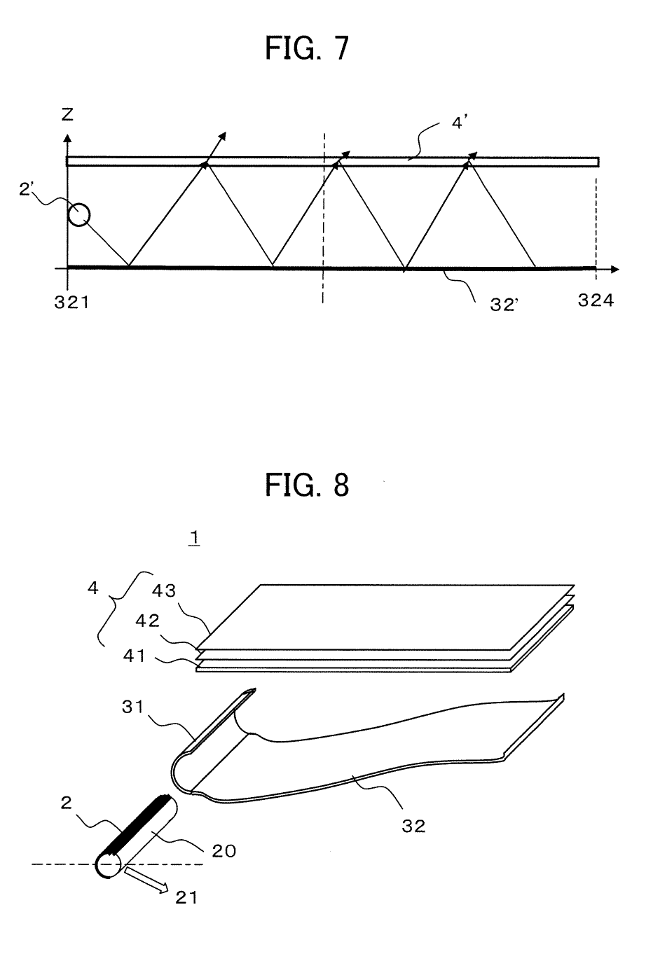

FIG. 7 is a ray diagram showing a case where the reflecting layer is formed in a planar shape for comparison. Since the rays of light emitted by the linear light source 2′ simply repeat the reflection and the transmission at regular intervals between the base part 32′ of the reflecting layer and the outlet layer 4′, the ray density in the X direction is substantially constant. Actually, the intensity of the light gradually attenuates during the repetition of the reflection and the transmission. Thus, the luminance distribution on the outlet layer 4′ becomes high in the vicinity of the linear light source 2′ and decreases with the distance from the linear light source 2′. As above, In the cases where the reflecting layer is in a planar shape, it is difficult to uniformize the luminance distribution on the outlet layer 4′. Further, it is also difficult to increase the ray density in the central part of the outlet layer and place the luminance peak in the central part of the screen.

According to this embodiment, the base part of the reflecting layer is formed so that its cross section is in the shape of a curved line, by which the luminance distribution on the outlet layer 4 can be more uniformized throughout the area from the vicinity of the linear light source 2 to the distal end in the X direction.

### Third Embodiment

FIG. 8 is a schematic diagram showing the configuration of an illumination device in accordance with a third embodiment of the present invention. In the third embodiment, the composition of the linear light source 2 in the first embodiment (FIG. 2) is modified.

The linear light source 2 is provided with an opening part 20 for restricting its light emitting direction. The size (opening angle) of the opening part 20 is set at approximately 180° around the linear light source 2. The opening part 20 is directed toward the base part 32 of the reflecting layer 3 (in the direction of the arrow 21). By directing the opening part 20 toward the base part 32, rays of light propagating from the linear light source 2 directly toward a part of the outlet layer 4 in the vicinity of the linear light source 2 are blocked. Consequently, excessive ray density in the vicinity of the linear light source 2 can be prevented and the luminance distribution of the backlight unit can be uniformized.

### Fourth Embodiment

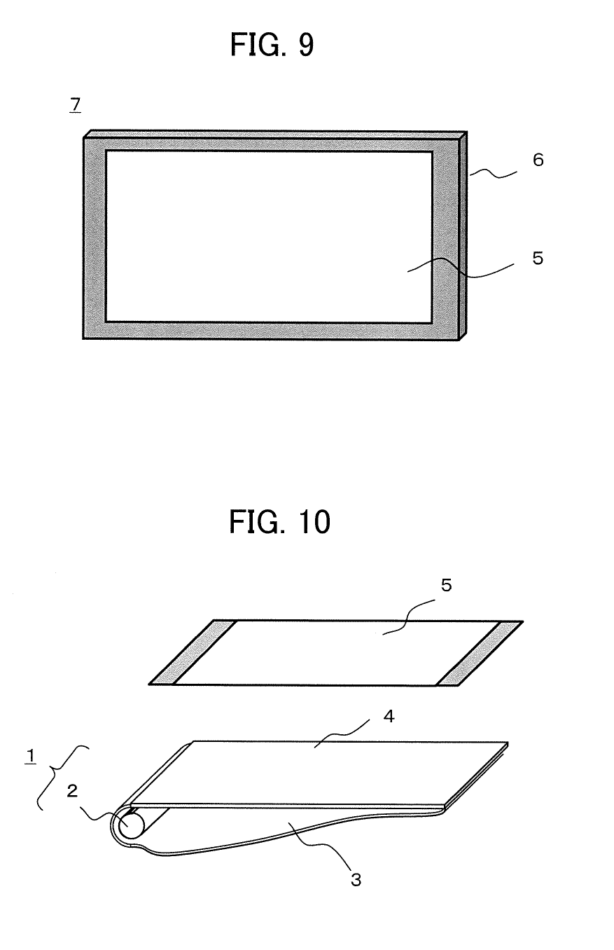

A fourth embodiment of the present invention will be described below with reference to FIGS. 9 and 10. In the fourth embodiment, an image display device equipped with the backlight unit illustrated in any one of the first through third embodiments will be described.

FIG. 9 is a front view showing a liquid crystal display 7 as an example of the image display device according to this embodiment. FIG. 10 is a schematic diagram showing the internal configuration of the liquid crystal display 7 of FIG. 9. FIG. 10 shows a case where the backlight unit 1 described in the first embodiment is installed in the liquid crystal display 7. The liquid crystal display 7 is formed by attaching a liquid crystal display element (liquid crystal panel) 5 and the backlight unit 1 (for illuminating the liquid crystal display element 5) to a housing 6 and further installing an image signal processing unit, a liquid crystal element driving unit, a power supply, etc. (unshown) in the housing 6.

The liquid crystal display element 5 displays images according to driving signals input thereto. Specifically, out of the light incident upon the liquid crystal display element 5 from the backlight unit 1, only light polarized in a particular direction (polarized light in a particular polarization angle) is selectively input to a liquid crystal layer having liquid crystal cells. Liquid crystals in each liquid crystal cell move according to the driving signal and thereby rotate the polarization angle of the polarized light, allowing the polarized light to emerge from the liquid crystal display element 5. The liquid crystal display element 5 may also be designed to display color images, by use of color filters applied to the light emerging from the liquid crystal cells. Color filters transmitting (letting through) more than the three colors (red, green, blue), such as yellow and magenta, can also be used.

The liquid crystal display 7 in this embodiment, equipped with the low-profile and lightweight backlight unit 1, can be implemented as a low-profile and lightweight display device. Further, images can be displayed on the screen with uniform brightness thanks to the uniform luminance distribution of the backlight 1. Furthermore, by using the backlight having the luminance distribution where luminance is enhanced in the central part of the outlet layer as described in the second embodiment, the luminance of the images in the central part of the display screen can be increased more than in the peripheral part of the display screen. Thus, an image display device capable of displaying images easily viewable to the viewers and excelling in the power efficiency can be provided.

Incidentally, the linear light source 2 in the backlight unit 1 may either be placed at any position selected from positions corresponding to the top, the bottom, the right end and the left end of the display screen. It is possible to arrange two or more linear light sources 2 in the backlight unit 1. It is also possible to arrange a plurality of backlight units 1 in a matrix for one liquid crystal display element 5. In this case, the power efficiency can be improved further by executing the so-called “area control” (independently controlling the light emission of each backlight unit according to the in-screen distribution of the image signal).

While several embodiments in accordance with the present invention have been described above, the present invention is not to be restricted to these particular illustrative embodiments. It goes without saying that the present invention includes a variety of configurations combining the elements described in the embodiments.

What is claimed is:

1. An illumination device comprising:
a linear light source;
a reflecting layer which reflects light emitted by the linear light source; and
an outlet layer which faces the reflecting layer and outputs illuminating light;
wherein the reflecting layer and the outlet layer face each other via space, and
the linear light source is arranged at an end of the space, and
the outlet layer is a semi-transmissive layer which transmits part of incident light while reflecting part of the incident light.

2. The illumination device according to claim 1, wherein:
a cross-sectional shape of the reflecting layer is set as a curved line extending along a direction orthogonal to the lengthwise direction of the linear light source, and
the curved-line shape has an apex, which is concave in an illuminating direction, in a section from a position close to the linear light source to a central position of the reflecting layer and an inflection point, where the rate of change of the gradient of the curved line equals zero, in a section from the apex to a distal end of the reflecting layer.

3. The illumination device according to claim 1, wherein:
the linear light source is provided with an opening part for restricting the emitting direction of the light emitted by the linear light source, and
the opening part is directed toward the reflecting layer and blocks light propagating from the linear light source toward the outlet layer.

4. An image display device comprising:
a liquid crystal display element for displaying images; and
the illumination device according to claim 1 as a backlight unit for illuminating the liquid crystal display element.

5. The image display device according to claim 4, wherein:
the backlight unit has a luminance distribution where luminance is enhanced in a central part of the outlet layer, and
luminance of the images displayed on a display screen implemented by the liquid crystal display element is higher in a central part of the screen than in a peripheral part of the screen.
